(19) United States
(12) Patent Application Publication
(10) Pub. No.: US 2019/0124486 A1
(43) Pub. Date: Apr. 25, 2019

(54) SYSTEM AND METHOD FOR OPEN PHONE ENABLED DEVICE

(71) Applicant: TUBE Incorporated, Chelmsford, MA (US)

(72) Inventors: Shantigram Jagannath, Chelmsford, MA (US); Harjot Singh Saluja, Nashua, MA (US); Sharmistha Chatterjee, Karnataka (IN); Julia Hudson Metcalf, Melrose, MA (US)

(73) Assignee: TUBE Incorporated, Chelmsford, MA (US)

(21) Appl. No.: 16/164,247

(22) Filed: Oct. 18, 2018

Related U.S. Application Data
(60) Provisional application No. 62/574,288, filed on Oct. 19, 2017.

(51) Int. Cl. H04W 4/24; H04W 4/23; H04L 12/14; H04M 1/725; H04M 15/00; G06Q 30/02

(52) U.S. Cl. CPC H04W 4/24; H04W 4/23; H04L 12/1475; H04M 1/72522; H04W 88/16; H04M 15/846; G06Q 30/0267; G06Q 30/0236; H04M 15/09

(57) ABSTRACT

According to various embodiments, an open phone device providing free access to subscribers upon purchase of the device is disclosed. The device may be a mobile device. The device may further include device layer capabilities allowing subscribers to purchase the device at a subsidized cost without any recurring monthly expenses. The device may further include a single integrated service offered to customers to purchase the device and use free data services. The device may be pre-loaded with free data apps.

### CROSS-REFERENCE TO RELATED APPLICATIONS

This application claims priority to provisional application 62/574,288, filed on Oct. 19, 2017, which is herein incorporated by reference in its entirety.

### TECHNICAL FIELD

The present invention relates generally to systems and methods related to mobile devices used to access cellular or Wi-Fi data services and more particularly to introducing various free data services available on a mobile device immediately after purchasing the mobile device and subscribing to an operator network.

### BACKGROUND OF THE INVENTION

Smartphones all over the world continue to consume massive amounts of data irrespective of operator networks, markets, and subscriber segments. Even though differences in data consumption plans exist today, the most motivating factors for increase in data usage includes more sophisticated LTE, 4G, 5G technology, improved device capabilities, attractive data plans, and increase in data intensive content. Popular data driven, highly utilized mobile programs include streaming music, watching video, social networking, and collaboration apps like WhatsApp Messenger, Facebook, and Instagram.

To match demand and supply of increasing data usage and rising data costs paid by subscribers, network operators have come up with better plans and introduced time-dependent prices to balance the cost of congestion during peak periods with that of offering lower prices during off-peak periods. Moreover, many sponsors (e.g. content partners, brands, advertisers) have come up with sponsored data campaigns where some or all of the data used by the app is sponsored by them. Sponsors have collaborated with network operators to run sponsorship campaigns during periods of low network utilization. However, while such solutions have increased the use of sponsored data and decreased data cost to some extent, it has failed to provide a permanent solution for using free mobile data every month in a user-friendly convenient manner.

One of the ways to control a subscriber's increasing mobile data cost is to allow monthly free data immediately after the purchase of the mobile device. However, offering a free data service to mobile subscribers upon purchase of a mobile device conventionally would lead to problems with the free data service offered during purchase and mobile data connectivity provided by operators. Presently, the purchase of a mobile device is separate from the purchase of the service on the mobile device because there is no easy way to tie the service to the mobile device and to pay for the usage that is limited to the mobile device. Hence, users have to purchase a mobile device and have a separate relationship with the mobile device operator, either through a contract or as a monthly purchase of service packs.

Thus, there is a need for additional improvements in reducing data cost through some free data and operator tie-up services along with enhancing user friendliness and the overall mobile device user experience.

### SUMMARY OF THE INVENTION

According to various embodiments, a system for providing free data access to subscribers upon purchase of an open phone enabled device is disclosed. The system includes an activity center on the open phone enabled device, where the activity center is configured to recommend sponsor engagement actions and reward free data access when the sponsor engagement actions are performed. The system further includes a custom campaign management portal (CCMP) configured to allow advertisers to sponsor content or data on one or more operator networks, where the sponsored data is free on the open phone enabled device. The system also includes a customer management portal (CMP) configured to manage data balance accounts based on data usage of the open phone enabled device.

According to various embodiments, a method for providing free data access to subscribers upon purchase of an open phone enabled device is disclosed. The method includes configuring an activity center on the open phone enabled device to recommend sponsor engagement actions and reward free data access when the sponsor engagement actions are performed. The method additionally includes configuring an over-the-top mobile service (OMS) APN gateway to serve as an intermediate gateway server between one or more operator networks and one or more open phone enabled devices in order to authenticate and manage data usage on the open phone enabled device. The method further includes configuring a custom campaign management portal (CCMP) to allow advertisers to sponsor content or data on the one or more operator networks, where the sponsored data is free on the open phone enabled device. The method also includes configuring a customer management portal (CMP) to manage data balance accounts based on data usage of the open phone enabled device.

According to various embodiments, a system for providing free data access to subscribers upon purchase of an open phone enabled device is disclosed. The system includes an activity center on the open phone enabled device, where the activity center is configured to recommend sponsor engagement actions and reward free data access when the sponsor engagement actions are performed. The system additionally includes an over-the-top mobile service (OMS) APN gateway configured to serve as an intermediate gateway server between one or more operator networks and one or more open phone enabled devices in order to authenticate and manage data usage on the open phone enabled device. The system further includes a custom campaign management portal (CCMP) configured to allow advertisers to sponsor content or data on one or more operator networks, where the sponsored data is free on the open phone enabled device. The system also includes a customer management portal (CMP) configured to manage data balance accounts based on data usage of the open phone enabled device.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1A is a diagram of a sectionalized home screen of an open phone enabled device according to an embodiment of the present invention;

FIG. 1B is a diagram of a monetization driven home screen of an open phone enabled device according to an embodiment of the present invention;

FIG. 2 is a diagram of free data settings on an open phone enabled device according to an embodiment of the present invention;

FIG. 3A is a diagram of connectivity to an OMS APN gateway from GGSN/PGW according to an embodiment of the present invention;

FIG. 3B is a diagram of connectivity to an OMS APN gateway through a VPN server according to an embodiment of the present invention;

FIG. 3C is a diagram of connectivity to an OMS APN gateway through an Internet APN according to an embodiment of the present invention;

FIG. 4 is a diagram of open phone enabled analytics usage according to an embodiment of the present invention;

FIG. 5 is a diagram of an open phone enabled ecosystem according to an embodiment of the present invention;

FIG. 6 is a diagram of sponsored data access through an APN gateway according to an embodiment of the present invention; and

FIG. 7 is a flow chart of free or payable data access through an open phone enabled device according to an embodiment of the present invention.

### DETAILED DESCRIPTION OF THE INVENTION

According to various embodiments, disclosed herein is a system and method for introducing various free data services available on a mobile device from the point a customer purchases the mobile device and subscribes to an operator network. Free mobile data of any kind (e.g. data, SMS, call) may be accessible to authorized end users by enabling an organized user-friendly home screen where at any time the mobile user can see the amount of data already used and the allowable free data limit. App-monetization is strategized by categorizing and bundling similar apps together in the home screen, allowing easy look-up of services and advertisements, as well as the download of free apps. As incentives of using free data at the subscriber end increase through a one-time small subsidized payment of the mobile device, brands, content partners, and advertisers may discover lucrative ways to increase the business potential by gathering statistics of usage data (with or without location services) and targeting potential customers through free apps and advertisements.

An open phone device is one which includes limited mobile data as a service free for the consumer every month with additional free mobile data for apps that are sponsored by their respective brands. The embodiments disclosed herein solve common problems associated with huge mobile data costs, user-friendliness, and organization of free apps and advertisements on mobile devices, can boost revenue potential in the mobile app-ecosystem, and enhance a mobile user's experience, in a secured manner. The embodiments disclosed herein allow a seamless end-user experience by selectively categorizing free mobile apps/advertisements and displaying them in different sections of the mobile UI home screen. As this service allows easy usage of free data and encourages such usage, this incentive helps in increased data usage benefitting advertisers, brands, and content partners to come up with higher rates of targeted user advertisements in these free data apps.

The user is presented with an organized home screen where similar free mobile apps/advertisements are bundled together in a section with a caption, while the current data usage as well as total usage limit is presented in a top most section of the home screen. The user is provided with an option of setting the data limit per free data app based on their desired level of usage and depth of user-interest. The open phone device service allows flexibility to turn on/off mobile data from a single button in the device settings, giving users the flexibility of using only free data after an initial subsidized payment of mobile device. The open phone device preloads free data apps in a newly purchased mobile device, allowing users to enjoy free data facility for these preloaded apps as well as sponsored apps.

Data cost may be reduced by offering a capability referred to herein as “open-phone” that is enabled once the user purchases a mobile device. A device with “open-phone” capabilities allow for the user to get a free quota every month and can earn more data by engaging with sponsors. Further, users can become more engaged with sponsors when more user-friendly design and services are available on open-phone enabled devices. Hence app-makers, brands, and sponsors can make use of an advanced user interface in a mobile device's home screen to motivate and attract users to use free apps based on their interest. It will save search time at the user end to navigate to the app of their choice as well as provide them with ads, rewards, and incentives that best suits the particular user.

The free data apps increase user-engagement by enhancing user-friendliness in the following means. (1) Similar mobile apps are compartmentalized in a group/section with a meaningful heading to make it easier for users to access. For instance, video ads may be bundled together in one section while news apps are bundled together in another section. (2) A display is visible on the home screen of the total eligibility limit of free data from different free sponsored data apps. (3) A display is visible on the home screen of free data already used by different free apps/sponsored data apps. (4) A turn on/turn off mobile data button is included in the device settings allowing users to turn on non-sponsored payable mobile data, allowing them to use other apps together with sponsored apps. This also gives users flexibility to turn off mobile data, allowing them to use only toll-free sponsored data apps. (5) Other mobile device settings include setting the number of times an ad can be viewed or an app can be browsed, as well as setting the data limit for each app. (6) A separate app marketplace is provided to download free data apps and sponsored data apps. (7) The mobile device is preloaded with different categories of free data apps so that these categories are available when the subscriber makes a purchase. (8) A free data quota is given every month, where the user can earn a higher data quota by engaging with sponsors. (9) Similar websites/services are aggregated through a single mobile app, accessible through the home screen.

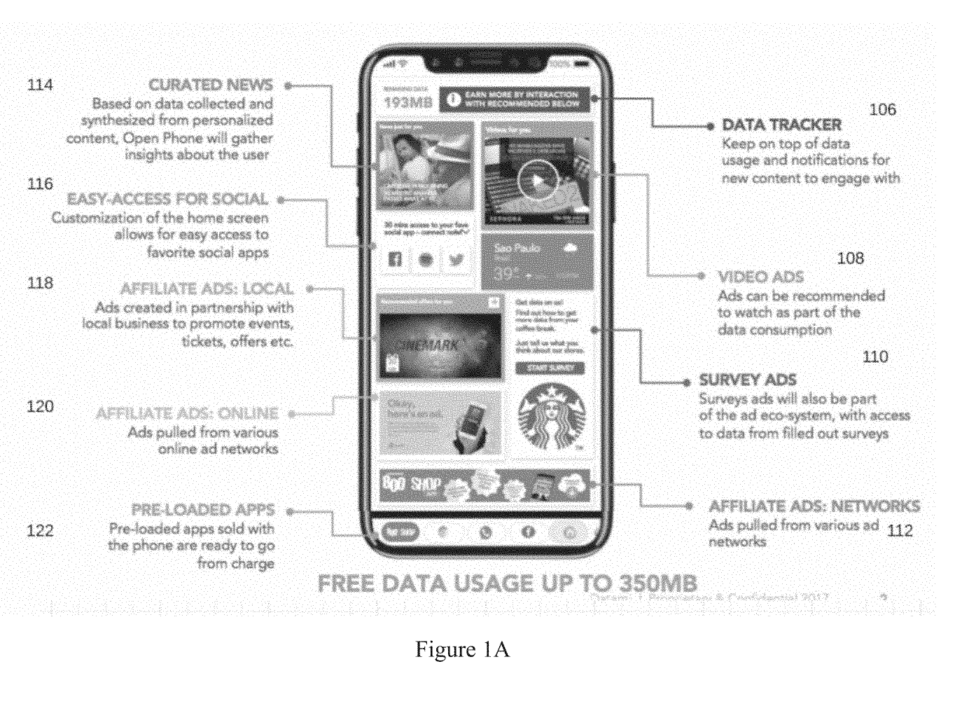

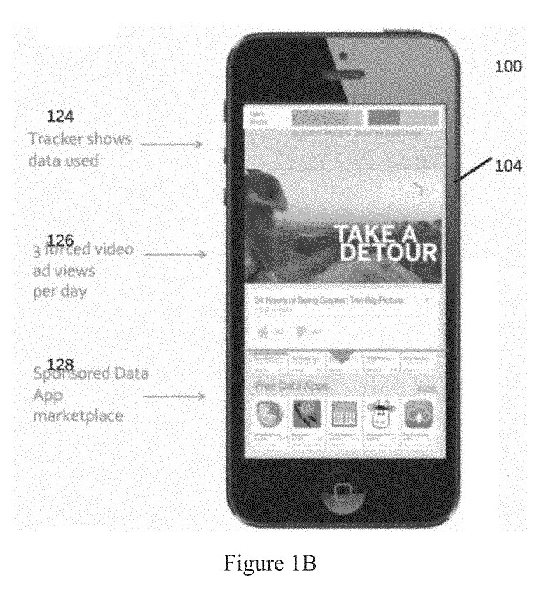

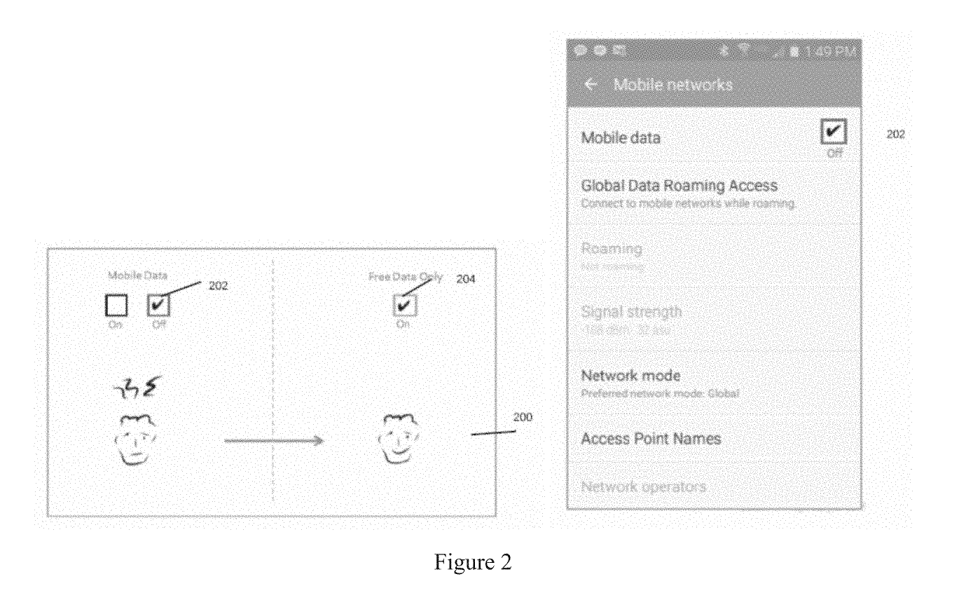

According to various embodiments, the system components may include an open phone enabled mobile device that includes an enhanced user-interface on the home screen with sections for different types of free data apps and a settings button to allow user-selection of free data, as illustrated in FIGS. 1a, 1b, and 2. An open phone enabled mobile device may provide free data access to subscribers upon the purchase of the mobile device. Mobile device layer capabilities may allow subscribers to purchase the mobile device at a subsidized cost without any recurring monthly expenses. A single integrated service may be offered to customers to purchase the device and use free data services, as well as having free data apps pre-loaded on the device.

FIG. 1a shows a sectionalized home screen with different types of apps and FIG. 1b shows a monetization driven home screen. FIG. 2 shows free data settings in an open phone enabled mobile device. The home screen is rendered by a client on the open phone enabled device, which may be pre-loaded or downloaded by a user of the open phone enabled device. The home screens allow for an enhanced user-interface on the mobile device with sections for different types of free data apps like news apps, sports apps, gaming apps, apps serving ads catering to local business, ads from local online networks, video ads, survey ads, ads pulled in from ad-networks, social networking apps, user's personified ads pertaining to user's usage behavior at different locations, data tracking notifications, and an activity center that contains recommendations for actions the user can comply with to continue to use the open phone service or earn additional benefits, such as more free data. Each kind of app is well sectioned on the UI with an easy to understand heading and user accessibility. The home screens and the activity centers are rendered by client software on the open phone enabled device wherein the client software may be pre-loaded on the device or may be downloaded by the open phone user.

FIGS. 1a and 1b show an open phone enabled mobile device 100. FIG. 1a shows a sectionalized home screen 102 rendered by the client with different types of apps and FIG. 1b shows a monetization driven home screen 104 containing an activity center with recommended actions for the user. The mobile device 100 may be implemented in a variety of configurations including general computing devices such as desktop computers, laptop computers, tablets, networks appliances, or mobile devices such as mobile phones, smart phones, or smart watches, as nonlimiting examples. The mobile device 100 includes one or more processors for performing specific functions and memory for storing those functions. The home screens 102 and 104 are structurally organized and sectioned to allow easy user content selection from different types of free data apps or free ad services.

The sectionalized home screen 102 may include a data tracker section 106, a video ads section 108, a survey ads section 110, an affiliated network ads section 112, a curated news section 114, a social access section 116, an affiliated local ads section 118, an affiliated online ads section 120, and a pre-loaded apps section 122. The data tracker section 106 allows a user to keep on top of data usage and allows for notification of new content with which to engage. This provides the user with data usage notifications and displays the available data quota on the home screen, alerting users when their total data consumption approaches their free data limit. The video ads section 108 allows for video ads to be recommended to watch as part of data consumption. The survey ads section 110 allows access to additional data from filled out surveys. The affiliated network ads section 112, affiliated local ads section 118, and affiliated online ads section 120 include ads pulled from various networks, ads created in partnership with local businesses, and ads pulled from various online ad networks, respectively. The curated news section 114 includes personalized news content based on data collected and synthesized from the user of the open phone enabled mobile device 100. The social access section 116 includes a section for easy access to various social apps including Facebook, Spotify, and Twitter, as nonlimiting examples. The pre-loaded apps section 122 includes apps already installed on the mobile device 100 that are ready to use and free from charge. The home screen 102 is capable of hosting user-preference based applications in any section of the home screen and providing personified location-based updates to a user of the mobile device 100.

The monetization driven home screen 104 may include a data tracker section 124, an activity center 126, and a sponsored data app marketplace 128. The data tracker section 124 shows how much data has been used. The activity center 126 includes specific actions recommended for the user such as but not limited to watching forced video ad views per day. The user should comply with these actions to continue to maintain the open phone service or earn additional free data usage on the open phone service. The sponsored data app marketplace 128 includes additional apps to download for free based on ad sponsorships. Free data apps available on the mobile device 100 are subjected to additional data credits, credited through watching promotional content, or top up purchased by the user. The open phone enabled mobile device 100 has the flexibility of allowing users to increase/decrease their data usage limit per app or number of free data sessions viewed/browsed per app, ads viewed per ad-category across any app.

FIG. 2 shows the free data settings 200 in an open phone enabled mobile device 100. The free data settings 200 include a mobile data turn on/off button 202 to allows for turning off cellular data when running low or out of cellular data. The free data settings 200 also include a free data turn on/off button 204 to allows for staying connected through free (sponsored) data. The free data setting may also have the flexibility of viewing only pre-loaded free data applications or both free data application and payable data applications. This allows users to enjoy only sponsored and pre-loaded free data apps or to pay and use mobile data along with enjoying sponsored and pre-loaded free data apps. User preference settings may also include increasing or decreasing data usage limits per application, increasing or decreasing the number of free data sessions viewed or browsed per application, or increasing or decreasing ads viewed per ad-category across multiple applications.

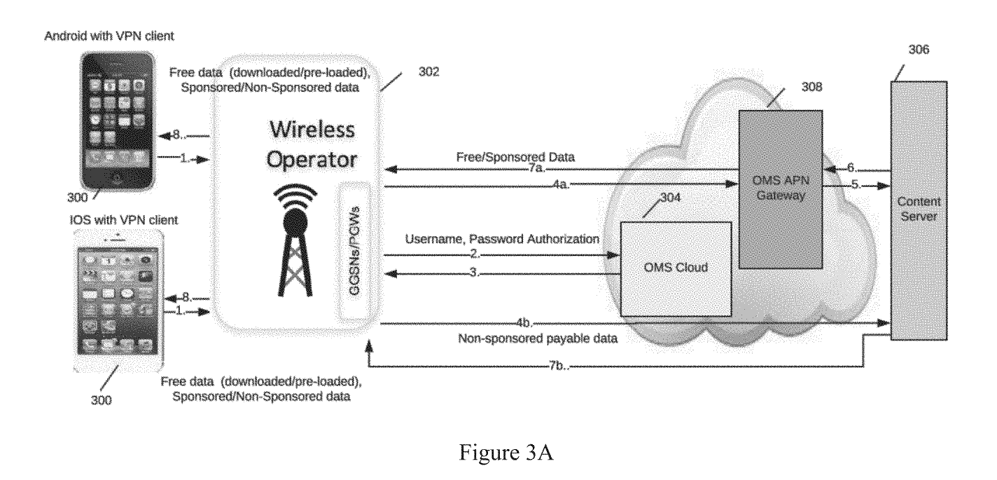

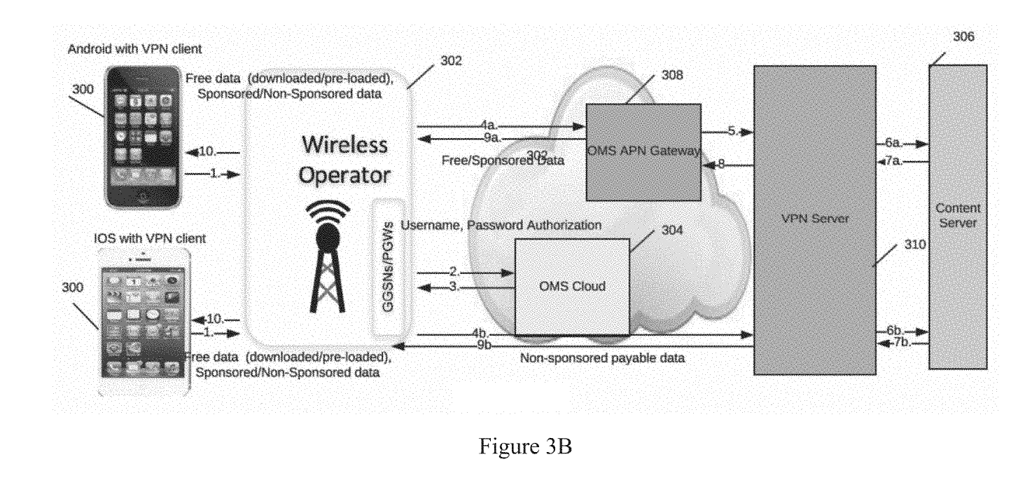

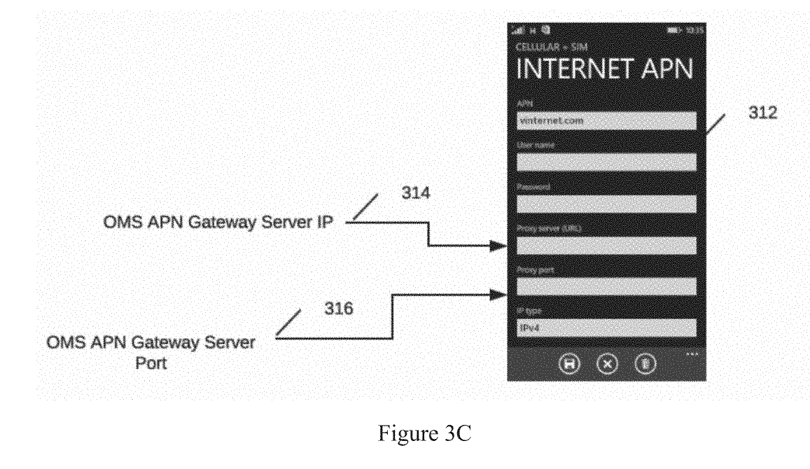

According to various embodiments, the system components may include an open phone access point name (APN) gateway that serves as an intermediate gateway server between operator networks and the open phone enabled mobile device, as illustrated in FIGS. 3a, 3b, and 3c. FIG. 3a shows connectivity to an Over-the-top Mobile Service (OMS) APN gateway from a GGSN or PGW. FIG. 3b shows connectivity to an OMS APN gateway through a VPN server. FIG. 3c shows connectivity to an OMS APN gateway through an Internet APN. In some other embodiments, the system may allow open phone enabled devices to connect with the backend content servers directly without the OMS APN. In such embodiments, the quantity and access of sponsored data is controlled by the client on the open phone enabled devices. In such embodiments, the wireless operator provides a service which may be turned on/off by the controller based on the amount of data usage and the amount of free data made available to the user.

FIG. 3a shows connectivity to an OMS APN gateway from a GGSN or PGW. Open phone enabled mobile devices 300 are connected to an operator network 302. The operator network 302 may be implemented as a single network or a combination of multiple networks. The operator network 302 may include but is not limited to wireless telecommunications networks, Zigbee, or other cellular communication networks involving 3G, 4G, 5G, and/or LTE. The operator network 302 is authorized via username/password authentication through an OMS cloud 304 to be discussed in more detail below. Once authorized, the operator network 302 is connected to a content server 306 via an OMS APN gateway 308 for free or sponsored data. For non-sponsored or payable data, the operator network 302 is connected directly to the content server 306.

FIG. 3b shows connectivity to an OMS APN gateway through a VPN server. This embodiment is similar to the embodiment shown in FIG. 3a, except operator network 302 is connected to the content server 306 through a VPN server 310. For free or sponsored data, the operator network 302 connects through the OMS APN gateway 308 and VPN server 310. For non-sponsored or payable data, the operator network 302 connects through the VPN server 310.

FIG. 3c shows connectivity to an OMS APN gateway through an Internet APN. The Internet APN 312 includes an OMS APN Gateway Server IP 314 and an OMS APN Gateway Server Port 316.

As such, an open phone enable device can be integrated to an operator network to support free data apps by: enabling virtual routing and forwarding configuration on the GGSN/PGW, connectivity setup as a VPN to a privately managed VPN server, default route setup for the APN for mobile internet, and voice and SMS service (if needed) for the users managed by the operator without allowing pass through of the APN gateway. The operator is authorized to authenticate the user SIM that are subscribed to the open phone by including MSISDN in the header through a header enrichment method or an authentication call to an authentication module to verify the user MSISDN. The OMS APN GW authenticates the SIM to the open phone enabled mobile device, the connectivity is only allowed if it is on an open phone enabled mobile device. The OMS APN gateway may authenticate single/dual SIM to the open phone device to allow connectivity to single or both SIMs if each of them are authorized to open phone free data services. The OMS APN GW manages the data connection with the device, including controlling the available data for sponsored data apps and free data apps and providing the relevant offers to the user such as granting rewards or other promotional content.

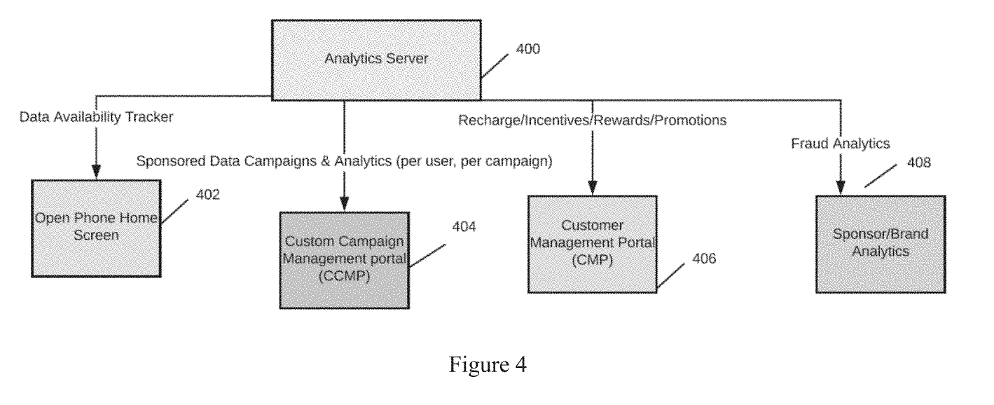

According to various embodiments, the system components may include an analytics server responsible for generating different data usage and fraud access statistics, campaign analytics, and reward grants. Open phone analytics usage via an analytics server 400 is illustrated in FIG. 4. The analytics server 400 may be included in the OMS cloud 304.

The analytics server 400 may track available data and display on an open phone home screen 402. The analytics server 400 may analyze sponsored data campaigns and analytics (either per user or per campaign) and send to a custom campaign management portal (CCMP) 404. The CCMP will be discussed in greater detail below. The analytics server 400 may also analyze recharge incentives, rewards, and promotions and send to a customer management portal (CMP) 406. The CMP will also be discussed in greater detail below. The analytics server 400 may analyze fraud analytics and send to a sponsor/brand analytics portal 408.

As such, the analytics server 400 is responsible for generating invoice generation for brands, sponsors, content partners. The analytics server 400 is also responsible for generating per user and per brand analytics for efficient targeting and retargeting opportunities through rewards, promotional offers, and other incentives. Authorization and analytics statistics helps in identifying un-authorized fraud access and provides additional security and fraud detection by blacklisting abusive users. The analytics server 400 provides an overview to operator networks and sponsors about user, campaign, and time based breakup of the data usage for preloaded/downloaded free data apps that comes with the open phone enabled device as well as other sponsored data apps.

The analytics server 400 may maintain an accounting of preloaded and downloaded sponsored apps and ads, where sponsored content is fetched through the OMS APN gateway by each open phone enabled device. The analytics server 400 may holds statistics of data accessed through open phone enabled devices by each campaign from each brand/sponsor on location based access, unauthorized or fraud access, overall data consumed by open phone devices displayed on home screen through data tracker, rewards, incentives, and promotional offers granted to each user, and, per user/per brand analytics, as nonlimiting examples.

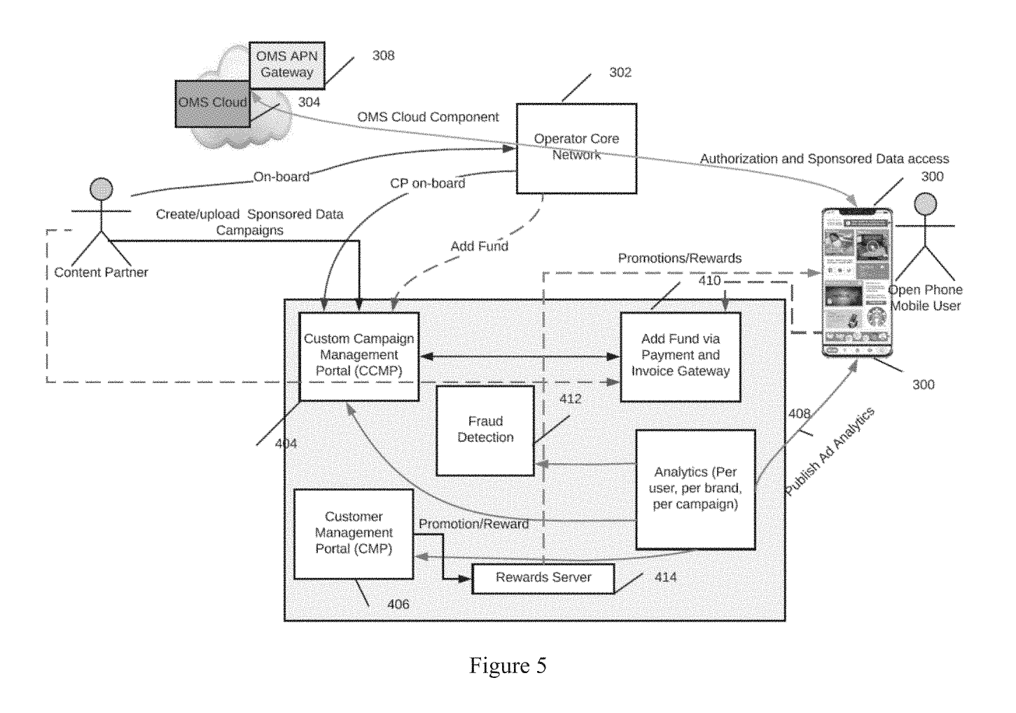

According to various embodiments, the system components may include one or more portal interfaces. As illustrated in FIG. 5, the portal interfaces include a custom campaign management portal (CCMP) 404 and a customer management portal (CMP) 406. The CCMP 404 and CMP 406 may be included in the OMS cloud 304, a back-end cloud service.

The CCMP 404 allows advertisers to sponsor advertisements on different operator networks and to configure sponsored ad campaigns. The CCMP 404 further allows individual advertisers to configure ads to be sponsored or can be pushed into the subscriber devices during valleys or when network capacity is high. This is further explained in U.S. application Ser. No. 16/136,517, which is herein incorporated by reference in its entirety. Once on board, a sponsor can sponsor any content on any operator network that has deployed sponsored services on open phone enabled mobile devices. The CCMP 404 provides a platform for campaign managers to register ads for their specific apps or create apps, upload creatives, and manage campaigns. The CCMP 404 is also configured to allow for pre-loaded content (apps and/or ads) for convenient use by the open phone enabled device from the time of purchase. CCMP 404 allows integration flexibility with ad-ecosystem partners to source campaigns from other partners. Further it allows on-boarding campaigns for sponsoring apps/advertisements. The CCMP 404 allows different sponsorship campaigns to be turned on/off from by sponsors to target different ads to different user segments at different period of network utilization. The CCMP 404 also provides flexibility to create campaigns with data rewards for targeted audience by viewing the analytics from the analytics server 400.

The CMP 406 manages customer balance accounts by allowing recharges, incentives, and promotions to allow access to free and payable data. The CMP 406 is responsible for recharging users where users with no credit are redirected to the CMP 406 where the promotions are offered to the users. The CMP 406 allows users to pay and use data and is responsible for recharging users.

As further illustrated in FIG. 5, the OMS cloud 304 may include a payment gateway module 410. The payment gateway module 410 allows direct user purchase opportunities. The OMS cloud 304 may further include a fraud detection module 412 that detects unauthorized or abusive users based on the analytics module 408. The OMS cloud 304 additionally includes a rewards server 414 with recharge incentives and promotions.

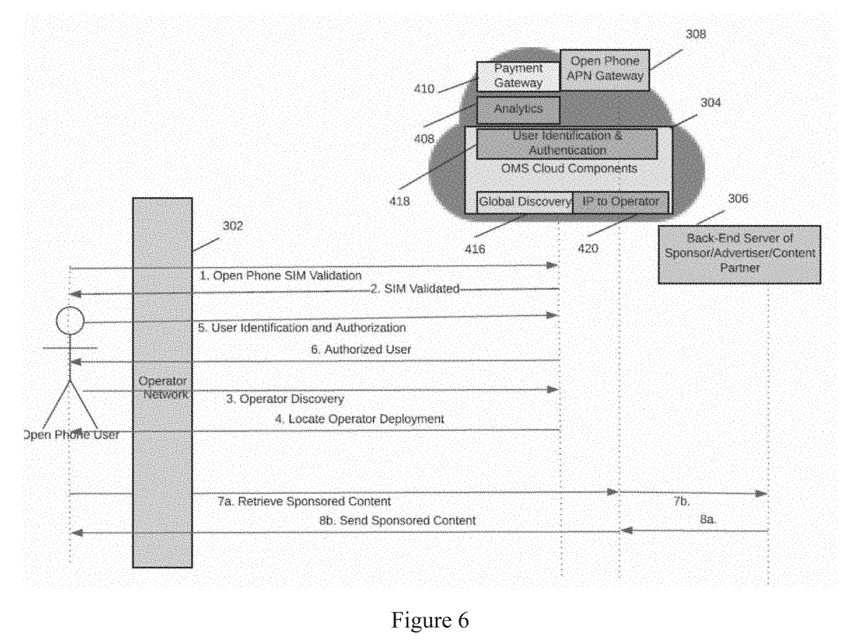

Additional elements of the OMS cloud 304 are illustrated in FIG. 6, which shows sponsored free data access by open phone enabled mobile devices 300 through an APN gateway 308. The OMS cloud 304 further includes a global discovery module 416, a user identification module 418, and an IP to operator module 420.

The global discovery module 416 may be connected to in order to locate operator specific cloud services and operator white-listed gateways.

The user identification module 418 may connect with an authentication app activated on the open phone enabled device 300 that validates the device with the operator connection. The authentication app successively connects to the user identification module 418 to authorize its request containing apps and ads requested by application based on sponsored ad availability in the campaign and user eligibility information available from operator/sponsor defined sponsorship rules in any given region.

The authentication app and user identification module 418 may authenticate each request made by the device app, website, or ad-network SDKs by matching application type, UUID, ads/apps sponsored with campaign configuration details. The authentication service, on being contacted by the device, is responsible for authorizing a configured list of websites/advertisements likely to be sponsored by the app. An ISP service re-validates the user's presence in the operator network before sending sponsored data (apps/ads) to an open phone enabled mobile device.

On successful authorization, all data passes through the APN Gateway 308. In case of authorization failure (like sponsored data limits exhaustion or presence in Wi-Fi network) the entire app and the ads displayed through the app are non-sponsored and it does not pass through the APN Gateway 308. All sponsored Ads are accounted by the Open Phone APN Gateway 308, which is then used by CCMP 404 and CMP 406 to offer rewards to the mobile user.

The OMS cloud 304 may further include a user registration module responsible for registering the user and generating UUID in the operator network, on being contacted by the service during its initialization phase, wherein the device stores this UUID and future ad requests to OMS cloud containing this UUID to signify any unique device's identity. The user registration module is also responsible for allowing operator header enrichment by the addition of MSISDN which authenticates the user SIMs that are subscribed to the open phone enabled mobile device.

The OMS cloud 304 may further include an IP to operator module 420, which identifies a user's presence in a cellular network and detects the right operator for single, dual, and/or quad SIM devices.

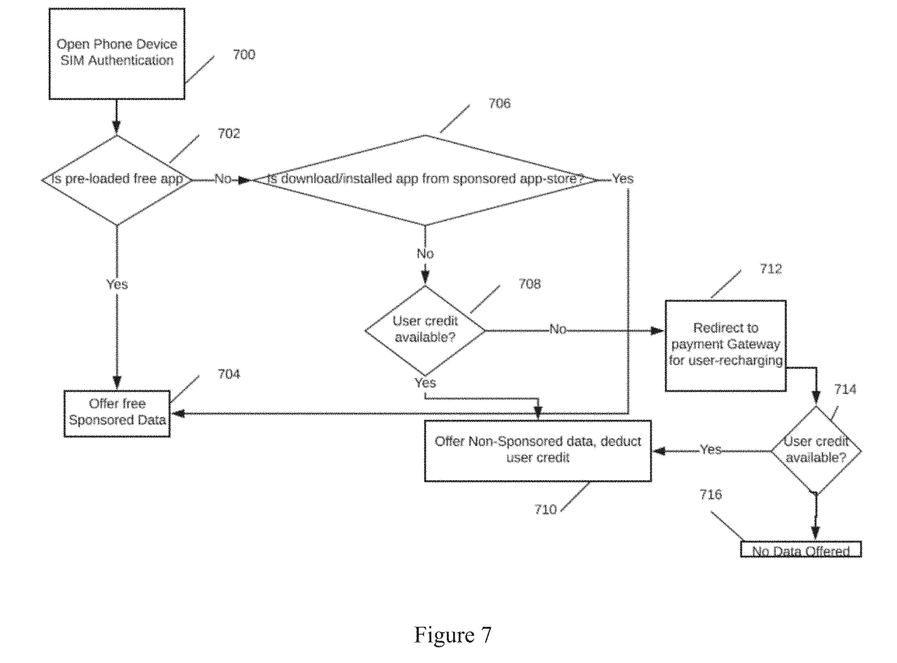

FIG. 7 illustrates free or payable data access through an open phone enabled mobile device. The open phone enabled device SIM is authenticated at step 700. Then, it is queried whether the app is a pre-loaded free app at step 702. If yes, free sponsored data is offered at step 704. If no, it is queried whether the downloaded/installed app is from the sponsored app-store at step 706. If yes, free sponsored data is again offered, returning to step 704. If no, it is queried whether user credit is available at step 708. If yes, non-sponsored data is offered and/or deducted from the user's credit at step 710. If no, then the user is redirected to payment gateway for user-recharging at step 712. At step 714, it is queried again whether user credit is available. If yes, a return to step 710 where non-sponsored data is offered and/or deducted from the user's credit. If no, no data is offered at step 716.

The following advantages and value are readily apparent from the system and methods described above. Monthly mobile data cost paid by subscribers is reduced to zero. App usability and user-friendliness is enhanced by categorizing different types of apps and suitably displaying them on the home screen. Several similar websites/services are aggregated in a single app making it visible on the home screen. Data usage notifications and display are available at any time on home screen alerting users when their total data consumption approaches their free data limit, which aids in easier balance management. Users are able to increase/decrease their data usage limit per app or number of free data sessions viewed/browsed per app, ads viewed per ad-category across any app for additional flexibility. A single turn on/off settings button available on mobile device allows users to turn off/on mobile data, thus allowing them to enjoy only sponsored free data apps or to pay and use mobile data along with enjoying sponsored free data apps. Multiple sponsors (brands, content partners, advertisers) are allowed to run one or more sponsored data campaigns per app to target same set of users. Sponsors can target wider audiences through pre-loaded mobile apps which are available to mobile users right from the day they make mobile purchase. The home screen is customizable with similar apps on home screen based on user-interest, behavior pattern. User behavior patterns can be used by sponsors to grant rewards and incentives through sponsored data campaigns. This increases cost-efficient retargeting opportunities across several apps. It also allows content partner to push the next relevant ad to the user either through ads section or through any mobile-app. Catering to serve personified ads in the ads section of the home screen leads to increases in ad-click through rate and data conversion rate. A one-time UI integration of mobile apps on the home screen is provided, which saves user search time to navigate to an app of their choice. The service can work independently and seamlessly across operator networks while mobile subscribers switch SIM or roams across different networks. Its capable of running in dual-SIM or quadruped SIM devices. Scalable interoperable solution can be deployed in any operator network integrated with any ad-network or 3^{rd}-party app. Embedding sponsored ad-content with own visual style and presentation format based on device screen size and model is simple. The solution has no dependencies on carrier network and mobile device platform, make and model. Detailed per user and per app analytics based on types of free and sponsored apps/ advertisements being viewed at different times of day is provided. Payment gateway integration allows for direct user purchase opportunity. Advanced analytics is provided for brands based on usages per app and several apps. Additional security is provided to prevent unauthorized user's access to obtain free data through the open phone enabled device.

This solution enables easy integration mechanism to diverse mobile platforms across multiple operator networks (3G, 4G, 5G, femto cell) to enhance user engagement where the subscriber just needs to make a purchase of a mobile phone at a subsidized payment without worrying about monthly data cost. The open phone enabled device affords easier execution at the user end by bringing in capabilities to structure the user interface carefully. The robust design allows bringing in more pre-loaded apps at the time of purchase by organizing different categories of apps in different sections of the home screen based on user behavior and usage characteristics. The solution further provides additional user flexibility of using free data apps (through open phone data connectivity), sponsored data apps and non-sponsored payable apps and websites by turning single on/off settings button allowing them to limit their usage to free apps only. In addition, it has an integrated payment gateway for users to pay and purchase mobile data plans.

The model allows easy distribution strategy by allowing sponsors (brands, content partners, advertisers) to run multiple sponsored data campaigns for free sponsored data apps to target and re-target subscribers based on mobile usage behavior across a single app/multiple apps. Further sponsors find it easier to market their apps to sponsored data consumers by launching their apps in a separate marketplace from where they can easily download the free data apps.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

What is claimed is:

1. A system for providing free data access to subscribers upon purchase of an open phone enabled device, the system comprising
an activity center on the open phone enabled device, the activity center configured to recommend sponsor engagement actions and reward free data access when the sponsor engagement actions are performed;
a custom campaign management portal (CCMP) configured to allow advertisers to sponsor content or data on one or more operator networks, the sponsored data being free on the open phone enabled device; and
customer management portal (CMP) configured to manage data balance accounts based on data usage of the open phone enabled device.

2. The system of claim 1, further comprising an over-the-top mobile service (OMS) APN gateway configured to serve as an intermediate gateway server between one or more operator networks and one or more open phone enabled devices in order to authenticate and manage data usage on the open phone enabled device.

3. The system of claim 2, wherein the OMS APN gateway is connected by one or more of the following:
setting up a virtual routing and forwarding configuration on a GGSN/PGW;
setting up a VPN server; and
setting up one or more proxy connections.

4. The system of claim 2, wherein the OMS APN gateway functions as a VPN server.

5. The system of claim 2, wherein the OMS APN gateway is further configured to manage available data for sponsored data apps and free data apps on the open phone enabled device.

6. The system of claim 2, wherein the OMS APN gateway, CCMP, and CMP are included on an OMS cloud service.

7. The system of claim 1, wherein the CCMP is further configured to allow advertisers to specify actions for users to perform to engage with their brands and to see analytics of the user engagement, the user engagement analytics being used to determine the amount of free data made available on the open phone enabled device.

8. The system of claim 1, wherein the open phone enabled device is a mobile device.

9. The system of claim 1, wherein the open phone enabled device is pre-loaded with free data apps.

10. The system of claim 1, wherein the open phone enabled device comprises a home screen being structurally organized and sectioned to allow user content selection from different types of free data apps or free ad services.

11. The system of claim 1, wherein the open phone enabled device displays free data consumption limits and an amount of total data consumed.

12. The system of claim 1, wherein the open phone enabled device comprises a free data application marketplace to enable users to download data free or sponsored applications.

13. The system of claim 1, wherein the open phone enabled device comprises a free data single turn on/off setting button.

14. The system of claim 1, wherein the CCMP is further configured to allow for pre-loadable content on the open phone enabled device.

15. The system of claim 1, wherein the CMP is further configured to recharge data balances and offer promotions.

16. The system of claim 1, further comprising an OMS analytics server configured to maintain an accounting of preloaded and downloaded sponsored apps and ads.

17. The system of claim 1, further comprising an OMS analytics server configured to hold statistics of data accessed through the open phone enabled device by one or more ad campaigns from one or more sponsors.

18. The system of claim 1, further comprising a client on the open phone enabled device, the client configured to manage and control an amount of available free data.

19. The system of claim 18, wherein the client is configured to interact with a cloud-based controller to activate or deactivate free data capabilities on the open phone enabled device.

20. A method for providing free data access to subscribers upon purchase of an open phone enabled device, the method comprising:
configuring an activity center on the open phone enabled device to recommend sponsor engagement actions and reward free data access when the sponsor engagement actions are performed;
configuring an over-the-top mobile service (OMS) APN gateway to serve as an intermediate gateway server between one or more operator networks and one or more open phone enabled devices in order to authenticate and manage data usage on the open phone enabled device;
configuring a custom campaign management portal (CCMP) to allow advertisers to sponsor content or data on the one or more operator networks, the sponsored data being free on the open phone enabled device; and
configuring a customer management portal (CMP) to manage data balance accounts based on data usage of the open phone enabled device.

21. The method of claim 20, further comprising configuring the OMS APN gateway to manage available data for sponsored data apps and free data apps on the open phone enabled device.

22. The method of claim 20, further comprising configuring the CCMP to allow for pre-loadable content on the open phone enabled device.

23. The method of claim 20, further comprising configuring an OMS analytics server configured to maintain an accounting of preloaded and downloaded sponsored apps and ads.

24. The method of claim 20, further comprising configuring the CMP to recharge data balances and offer promotions.

25. A system for providing free data access to subscribers upon purchase of an open phone enabled device, the system comprising:
an activity center on the open phone enabled device, the activity center configured to recommend sponsor engagement actions and reward free data access when the sponsor engagement actions are performed;
an over-the-top mobile service (OMS) APN gateway configured to serve as an intermediate gateway server between one or more operator networks and one or more open phone enabled devices in order to authenticate and manage data usage on the open phone enabled device;
a custom campaign management portal (CCMP) configured to allow advertisers to sponsor content or data on one or more operator networks, the sponsored data being free on the open phone enabled device; and
customer management portal (CMP) configured to manage data balance accounts based on data usage of the open phone enabled device.
